(19) United States
(12) Patent Application Publication
(10) Pub. No.: US 2025/0266721 A1
(43) Pub. Date: Aug. 21, 2025

(54) CONTACTLESS POWER TRANSMISSION SYSTEM, POWER TRANSMISSION DEVICE, AND MOBILE BODY

(71) Applicant: HONDA MOTOR CO., LTD., Tokyo (JP)

(72) Inventor: Jin Katsuya, Wako-shi (JP)

(21) Appl. No.: 19/052,324

(22) Filed: Feb. 13, 2025

(30) Foreign Application Priority Data
Feb. 19, 2024 (JP) 2024-023095

(51) Int. Cl. H02J 50/80; B60L 53/122; B60L 53/126; B60L 53/30; H02J 50/10

(52) U.S. Cl. CPC H02J 50/80; B60L 53/122; B60L 53/126; B60L 53/32; H02J 50/10; B60L 2210/40

(57) ABSTRACT

A contactless power transmission system includes a power transmission unit, a transmission power converting unit, and a power transmission-side control device. The power transmission unit includes a primary-side coil transmitting AC power that is contactlessly transmitted to a power reception device. The transmission power converting unit includes a plurality of transistors connected to the primary-side coil. The transmission power converting unit converts DC power supplied from a power supply unit into AC power. The power transmission-side control device sets transmission power of a transmission start initial period according to the power transmission unit to be less than a predetermined power. The power transmission-side control device changes transmission power in an increasing trend toward the predetermined power in accordance with elapse of time from start of power transmission performed using the power transmission unit.

### CROSS-REFERENCE TO RELATED APPLICATION

Priority is claimed on Japanese Patent Application No. 2024-023095, filed Feb. 19, 2024, the content of which is incorporated herein by reference.

### BACKGROUND OF THE INVENTION

### Field of the Invention

The present invention relates to a contactless power transmission system, a power transmission device, and a mobile body.

### Description of Related Art

In recent years, in order to allow more persons to secure access to sustainable and advanced energy with appropriate reliability, research and development relating to charging and discharging in a vehicle in which a secondary battery contributing to energy efficiency is mounted has been performed.

Conventionally, in a contactless power transmission system supplying electric power from a power transmission side to a power reception side through contactless power transmission, a system performing identification of a power reception side using a power transmission side and power transmission corresponding to a requested power of the power reception side on the basis of information transmitted from the power reception side to the power transmission side is known (for example, see Patent Document 1 represented below).
[Patent Document 1] Japanese Unexamined Patent Application, First Publication No. 2023-393

### SUMMARY OF THE INVENTION

In a technology relating to charging/discharging in a vehicle in which a secondary battery is mounted, in contactless power transmission for a vehicle during traveling, it is preferable to perform accurate vehicle identification quickly and appropriate power be transmitted according to a requested power for each of a plurality of traveling vehicles. For example, in the case of a traveling vehicle receiving power feeding from a power transmission-side coil disposed on a traveling road, it is preferable to establish communication between a power transmission side and a power reception side in a very short time such as several tens of ms and complete power transmission according to a requested power. For example, even in a case in which a plurality of traveling vehicles of which requested powers are different from each other are present under a mixed traffic environment in which inter-vehicle distances become small, and an interrupt occurs or the like, it is preferable to perform power transmission at an appropriate timing including a simultaneous timing for each of the plurality of traveling vehicles.

However, for example, in the system of the conventional technology described above, each of the vehicle and a ground power feeding device needs two different dedicated radio communication devices of a broad-band radio communication and narrow-band radio communication in addition to a power reception device or a power transmission device, and thus there is a problem that the system configuration becomes complicated. For example, in a case in which communication has not been stabilized in a very short time, or communication establishment has failed in a narrow-band radio communication for vehicle identification immediately before start of power feeding, an abnormality such as a power transmission failure or excessive power feeding may occur.

An aspect relating to the present invention is in view of the situations described above, and an object thereof is to provide a contactless power transmission system, a power transmission device, and a mobile body capable of performing appropriate power transmission for a plurality of different mobile bodies. Furthermore, it contributes to energy efficiency.

In order to solve the problems described above and achieve the related object, the present invention employs the following aspects.

(1): According to one aspect of the present invention, there is provided a contactless power transmission system including: a power reception-side coil, a power reception-side communication device, and a power reception-side control device configured to be mounted in a mobile body; and a power transmission device having at least one power transmission-side coil, a power transmission-side communication device, and a power transmission-side control device configured to be disposed in a movement path of the mobile body, in which the power reception-side communication device and the power transmission-side communication device transmit/receive first information using wireless first communication before a degree of coupling between the power reception-side coil and the power transmission-side coil reaches a predetermined level or more, after the first communication between the power reception-side communication device and the power transmission-side communication device or in a case in which the power reception-side coil and the power transmission-side coil are within a predetermined distance, the power reception-side coil transmits second information to the power transmission-side coil using second communication using an induced voltage of magnetic coupling, the power transmission-side coil contactlessly transmits power to the power reception-side coil after the second communication with the power reception-side coil, and the power reception-side control device and the power transmission-side control device control communication of the first information and the second information and control contactless power transmission between the power reception-side coil and the power transmission-side coil on the basis of the first information and the second information.

(2): In (1) described above, the first information transmitted from the power reception-side communication device to the power transmission-side communication device may include at least information relating to power transmission, the first information transmitted from the power transmission-side communication device to the power reception-side communication device may include at least key information, and the second information may include at least the key information.

(3): In (2) described above, the power transmission device includes at least one power transmission-side power converting unit that is connected to each of at least one power transmission-side coil and independently converts power supplied from a power supply, and the power transmission-side control device may independently control contactless power transmission using each of at least one power transmission-side coil in accordance with the information relating to power transmission associated with the key information received from the power reception-side coil by each of at least one power transmission-side coil on the basis of a combination of the key information and the information relating to power transmission.

(4): In (3) described above, the power transmission-side control device may transition the power transmission-side power converting unit from a stop state to a reception standby state of the second information after the key information is transmitted from the power transmission-side communication device to the power reception-side communication device, transition the power transmission-side power converting unit from the reception standby state to a search state in which a voltage pulse is output for estimating the degree of coupling after completion of collation of the key information received from the power reception-side coil by the power transmission-side coil, and transition the power transmission-side power converting unit to a power transmission control state in a case in which the degree of coupling has reached a predetermined threshold level or more in the search state and transition the power transmission-side power converting unit to the reception standby state in a case in which the degree of coupling has not reached the predetermined threshold level or more in the search state.

(5): In (4) described above, a power reception-side power converting unit that is mounted in the mobile body and is connected to the power reception-side coil is further included, and the power reception-side control device may transition the power reception-side power converting unit from a short-circuit state of the power reception-side coil to a transmission state of the second information after the key information is received from the power transmission-side communication device by the power reception-side communication device and transition the power reception-side power converting unit from the transmission state to a power reception standby state of power after transmission of the second information, and transition the power reception-side power converting unit to a power reception control state in a case in which a reception power has reached a predetermined power or more within a predetermined time in the power reception standby state and transition the power reception-side power converting unit to the transmission state in a case in which the reception power has not reached the predetermined power or more within the predetermined time in the power reception standby state.

(6): According to one aspect of the present invention, there is provided a power transmission device including: at least one power transmission-side coil configured to be disposed in a movement path of a mobile body and contactlessly transmits power to a power reception-side coil mounted in the mobile body; a power transmission-side communication device configured to transmit/receive first information using wireless first communication with a power reception-side communication device mounted in the mobile body before a degree of coupling between the power transmission-side coil and the power reception-side coil reaches a predetermined level or more; and a power transmission-side control device configured to control contactless power transmission between the power reception-side coil and the power transmission-side coil on the basis of second information received by the power transmission-side coil using second communication using an induced voltage of magnetic coupling between the power reception-side coil and the power transmission-side coil and the first information.

(7): In (6) described above, at least one power transmission-side power converting unit that is connected to each of at least one power transmission-side coil and independently converts power supplied from a power supply is further included, in which the first information received from the power reception-side communication device by the power transmission-side communication device includes at least information relating to power transmission, the first information transmitted to the power reception-side communication device by the power transmission-side communication device includes at least key information, the second information includes at least the key information, and the power transmission-side control device may independently control contactless power transmission using each of at least one power transmission-side coil in accordance with the information relating to power transmission associated with the key information received by each of at least one power transmission-side coil from the power reception-side coil on the basis of a combination of the key information and the information relating to power transmission.

(8): In (7) described above, the power transmission-side control device may transition the power transmission-side power converting unit from a stop state to a reception standby state of the second information after the key information is transmitted from the power transmission-side communication device to the power reception-side communication device, transition the power transmission-side power converting unit from the reception standby state to a search state in which a voltage pulse is output for estimating the degree of coupling after completion of collation of the key information received from the power reception-side coil by the power transmission-side coil, and transition the power transmission-side power converting unit to a power transmission control state in a case in which the degree of coupling has reached a predetermined threshold level or more in the search state and transition the power transmission-side power converting unit to the reception standby state in a case in which the degree of coupling has not reached the predetermined threshold level or more in the search state.

(9): According to one aspect of the present invention, there is provided a mobile body including: a power reception-side coil configured to receive power contactlessly transmitted from a power transmission-side coil; a power reception-side communication device configured to transmit/receive first information using wireless first communication with a power transmission-side communication device included in a power transmission device before a degree of coupling between the power transmission-side coil and the power reception-side coil reaches a predetermined level or more; and a power reception-side control device configured to transmit second information to the power transmission-side coil using second communication using an induced voltage of magnetic coupling between the power reception-side coil and the power transmission-side coil.

(10): In (9) described above, a power reception-side power converting unit configured to be connected to the power reception-side coil is further included, and the first information transmitted to the power transmission-side communication device by the power reception-side communication device includes at least information relating to power transmission, the first information received from the power transmission-side communication device by the power reception-side communication device includes at least key information, the second information includes at least the key information, and the power reception-side control device may transition the power reception-side power converting unit from a short-circuit state of the power reception-side coil to a transmission state of the second information after the key information is received from the power transmission-side communication device by the power reception-side communication device and transition the power reception-side power converting unit from the transmission state to a power reception standby state of power after transmission of the second information, and transition the power reception-side power converting unit to a power reception control state in a case in which a reception power has reached a predetermined power or more within a predetermined time in the power reception standby state and transition the power reception-side power converting unit to the transmission state in a case in which the reception power has not reached the predetermined power or more within the predetermined time in the power reception standby state.

According to (1) described above, by including the power reception-side communication device and the power transmission-side communication device performing communication of first information (first communication) and the power reception-side coil and the power transmission-side coil performing communication of second information (second communication) and contactless power transmission, for example, a special communication device for communication of the second information (second communication) is not required, and the system configuration can be prevented from becoming complicated.

In the case of (2) described above, for example, communication of the first information having a large volume can be performed using the power reception-side communication device and the power transmission-side communication device, and communication of the second information having a small volume required only for at least identification of a mobile body can be performed using the power reception-side coil and the power transmission-side coil. Since contactless power transmission is executed using the power reception-side coil and the power transmission-side coil of which paring is formed using communication and collation of key information, appropriate power transmission control and power reception control can be executed with high reliability.

In the case of (3) described above, for example, also in a case in which a plurality of sets of combinations of the power transmission-side coil and the power transmission-side power converting unit are connected to a common power supply, communication and collation of key information and power transmission are independently controlled for each of the combinations. In accordance with this, for example, under an environment in which a plurality of mobile bodies of which requested powers are different from each other are present or the like, power transmission can be performed with an appropriate timing and appropriate power.

In the case of (4) described above, by providing the search state of the power transmission-side power converting unit, in a case in which a degree of coupling between the power reception-side coil and the power transmission-side coil of which pairing is formed has reached a predetermined threshold or more that is appropriate for power transmission, power transmission control can be appropriately executed.

In the case of (5) described above, by providing the short-circuit state of the power reception-side power converting unit, unnecessary communication from the power reception-side coil to the power transmission-side coil can be prevented. By providing the power reception standby state of the power reception-side power converting unit, appropriate voltage detection can be performed in accordance with the search state of the power transmission-side power converting unit. In addition, in a case in which reception power appropriately increases in accompaniment with an increase in the degree of coupling between the power reception-side coil and the power transmission-side coil of which paring has been formed, power reception control can be appropriately executed.

According to (6) described above, by including the power transmission-side communication device performing communication of the first information (first communication) and the power transmission-side coil performing communication of the second information (second communication) and contactless power transmission, for example, a special communication device for communication of the second information is not required, and the system configuration can be inhibited from being complicated.

In the case of (7) described above, for example, communication of the first information having a large volume can be performed using the power transmission-side communication device, and communication of the second information having a small volume that is required only for at least identification of a mobile body can be performed using the power transmission-side coil. Since contactless power transmission is executed using the power reception-side coil and the power transmission-side coil of which paring is formed using communication and collation of key information, appropriate power transmission control can be executed with high reliability.

Also in a case in which a plurality of sets of combinations of the power transmission-side coil and the power transmission-side power converting unit are connected to a common power supply, communication and collation of key information and power transmission are independently controlled for each of the combinations. In accordance with this, for example, under an environment in which a plurality of mobile bodies of which requested powers are different from each other are present or the like, power transmission can be performed with an appropriate timing and appropriate power.

In the case of (8) described above, by providing the search state of the power transmission-side power converting unit, in a case in which the degree of coupling between the power reception-side coil and the power transmission-side coil of which pairing is formed has reached a predetermined threshold or more that is appropriate for power transmission, power transmission control can be appropriately executed.

According to (9) described above, by including the power reception-side communication device performing communication of the first information (first communication) and the power reception-side coil performing communication of the second information (second communication) and contactless power transmission, for example, a special communication device for communication of the second information is not required, and the system configuration can be inhibited from being complicated.

In the case of (10) described above, for example, communication of the first information having a large volume can be performed using the power reception-side communication device, and communication of the second information having a small volume required only for at least identification of a mobile body can be performed using the power reception-side coil. Since contactless power transmission is executed using the power reception-side coil and the power transmission-side coil of which paring is formed using communication and collation of key information, appropriate power reception control can be executed with high reliability.

By providing the short-circuit state of the power reception-side power converting unit, unnecessary communication from the power reception-side coil to the power transmission-side coil can be prevented. By providing the power reception standby state of the power reception-side power converting unit, appropriate voltage detection can be performed in accordance with the search state of the power transmission-side power converting unit. In addition, in a case in which reception power appropriately increases in accompaniment with an increase in the degree of coupling between the power reception-side coil and the power transmission-side coil of which paring has been formed, power reception control can be appropriately executed.

### BRIEF DESCRIPTION OF THE DRAWINGS

FIG. 1 is a diagram illustrating a configuration example of a contactless power transmission system according to an embodiment of the present invention.

FIG. 2 is a diagram illustrating a configuration example of a contactless power transmission system according to an embodiment of the present invention.

FIG. 3 is a diagram illustrating details of a configuration of a contactless power transmission system according to an embodiment of the present invention.

FIG. 4 is a diagram illustrating a configuration of a power transmission unit and a power reception unit of a contactless power transmission system according to an embodiment of the present invention.

FIG. 5 is a diagram illustrating a T-type equivalent circuit of a contactless power transmission system according to an embodiment of the present invention.

FIG. 6 is a diagram illustrating an example of operations of communication and power transmission accompanied with movement of a mobile body (vehicle) according to an embodiment of the present invention.

FIG. 7 is a graph diagram illustrating an example of a correspondence relation between electric power and efficiency according to a horizontal distance (a relative movement amount between a primary-side coil and a secondary-side coil in a direction parallel to a road surface) in a contactless power transmission system according to an embodiment of the present invention.

FIG. 8 is a flowchart illustrating a power reception-side process of a contactless power transmission system according to an embodiment of the present invention.

FIG. 9 is a flowchart illustrating a power transmission-side process of a contactless power transmission system according to an embodiment of the present invention.

FIG. 10 is a diagram illustrating one example of a correspondence relation of a power reception-side drive signal, a power reception-side voltage, a power transmission-side voltage, a power reception-side current, and a coupling coefficient at the time of communication between a primary-side coil and a secondary-side coil prior to start of power transmission in a contactless power transmission system according to an embodiment of the present invention.

### DETAILED DESCRIPTION OF THE INVENTION

Hereinafter, a contactless power transmission system according to an embodiment of the present invention will be described with reference to the attached drawings.

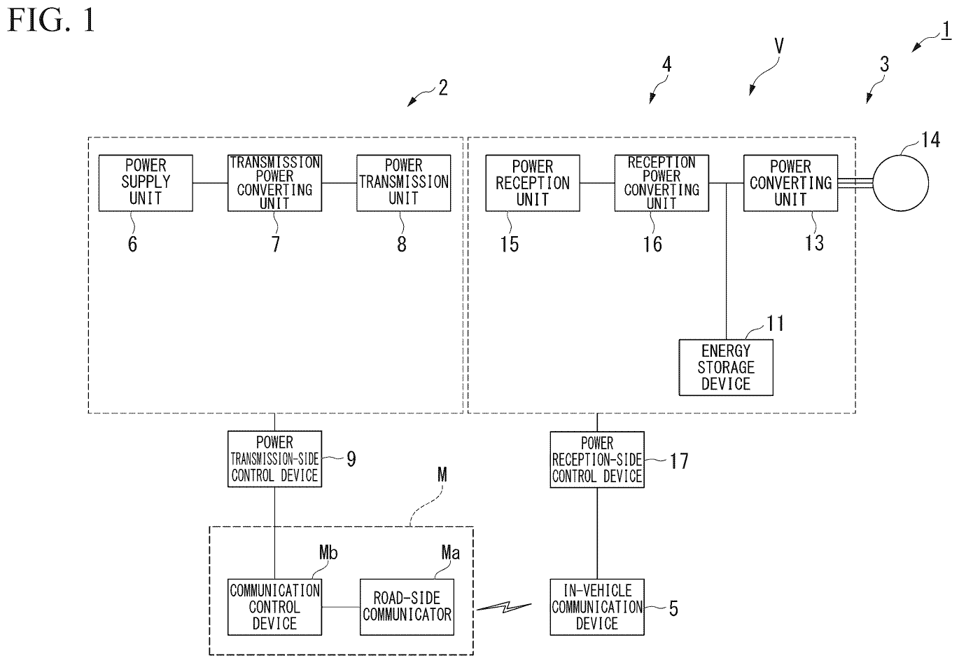

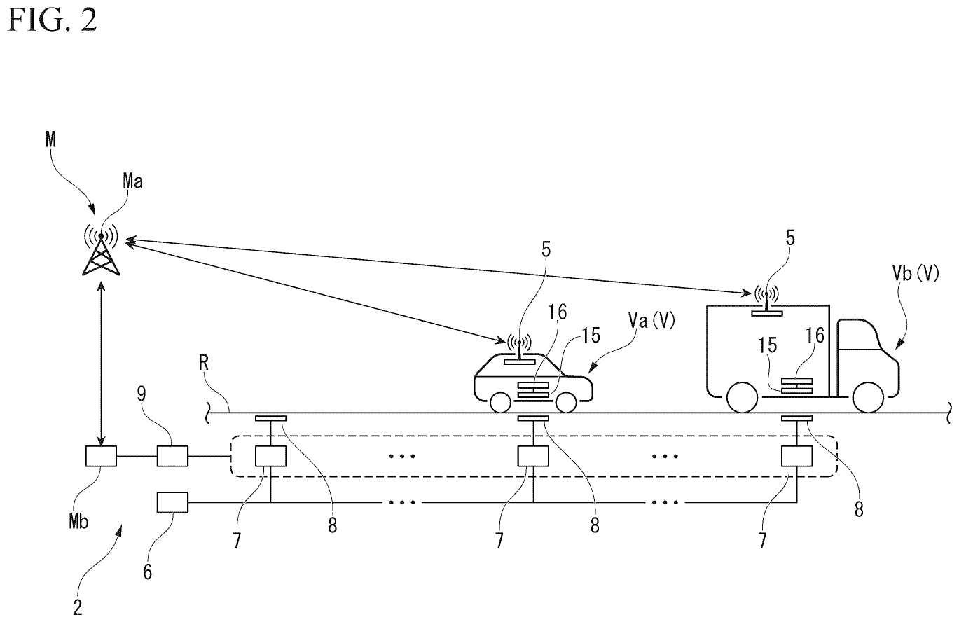

FIGS. 1 and 2 are diagrams illustrating a configuration example of a contactless power transmission system 1 according to an embodiment.

The contactless power transmission system 1 according to the embodiment, for example, supplies electric power from the outside (a movement path or the like) of a mobile body to the mobile body using contactless power transmission. The mobile body, for example, is a vehicle V or the like. The vehicle V is, for example, an electric vehicle such as an electric car, a hybrid vehicle, or a fuel cell vehicle. The outside (a movement path or the like) of the mobile body, for example, is a traveling road R of the vehicle V.

### (Contactless Power Transmission System)

As illustrated in FIGS. 1 and 2, the contactless power transmission system 1 according to the embodiment, for example, includes a power transmission device 2 disposed on a traveling road R of a vehicle V, a driving control device 3, a power reception device 4, and an in-vehicle communication device 5 mounted in the vehicle V.

The contactless power transmission system 1 according to the embodiment may, at least, include only an external constituent element (for example, the power transmission device 2) of the vehicle V, and power transmission may be contactlessly executed using a combination of constituent elements (for example, the driving control device 3, the power reception device 4, and the in-vehicle communication device 5) mounted in the vehicle V and the contactless power transmission system 1 disposed outside of the vehicle V. The contactless power transmission system 1 according to the embodiment may, at least, include only constituent elements (for example, the driving control device 3, the power reception device 4, and the in-vehicle communication device 5) mounted in the vehicle V, and power transmission may be contactlessly executed using a combination of an external constituent element (for example, the power transmission device) 2 of the vehicle V and the contactless power transmission system 1 mounted in the vehicle V.

The power transmission device 2, for example, includes a communication system M configuring a power transmission-side communication device, a power supply unit 6, at least one set (for example, a plurality of sets) of a transmission power converting unit 7 and a power transmission unit 8, and a power transmission-side control device 9.

The communication system M wirelessly performs communication with the in-vehicle communication device 5 configuring a power reception-side communication device mounted in the vehicle V. The communication system M, for example, configures at least a part of a system such as an electronic toll collection system (ETC) on toll roads used for electronically collecting tolls and a system for exchanging road traffic information and various types of information for driving assistance.

The communication system M, for example, includes at least one road-side communicator Ma wirelessly communicating with the in-vehicle communication device 5 of the vehicle V using so-called road-to-vehicle communication and a communication control device Mb. Each of at least one or more road-side communicators Ma and the communication control device Mb, for example, are connected via a wired or wireless communication network. The communication network, for example, includes the Internet, a mobile communication network, a local area network (LAN), a wide area network (WAN), and the like.

The road-side communicators Ma, for example, are disposed to be apart by a predetermined distance on an upstream side of coupling sections (communication sections CS1 and CS2 and a power transmission section TS) to be described below in a traveling road R of the vehicle. The road-side communicator Ma includes various communication devices such as an antenna for radio communication and the like.

The communication control device Mb controls operations of all the road-side communicator Ma associated in advance. The communication control device Mb, for example, is a software functional unit that functions by executing a predetermined program using a processor such as a central processing unit (CPU). The software functional unit is an ECU that includes a processor such as a CPU, a read only memory (ROM) storing a program, a random access memory (RAM) temporarily storing data, and an electronic circuit such as a timer. At least a part of the communication control device Mb may be an integrated circuit such as a large scale integration (LSI).

The communication system M and the in-vehicle communication device 5, for example, respectively correspond to a primary authentication device and a secondary authentication device and exchange at least authentication information that is exclusively assigned to each vehicle V. The communication system M and the in-vehicle communication device 5, for example, attempt transmission/reception of first information using radio communication with the road-side communicator Ma and the in-vehicle communication device 5 of a surrounding vehicle V with a predetermined period or the like.

For example, the first information transmitted from the in-vehicle communication device 5 to the communication system M includes at least information relating to power transmission. The information relating to power transmission, for example, includes information of a power transmission request such as a requested power, a required frequency, and the like for power transmission from the power transmission device 2 to the vehicle V, information required for billing and payment for power transmission, and the like. The information required for billing and payment, for example, is information unique to the vehicle V like presence/absence and an identifier of an IC card, an in-vehicle transponder, or the like for toll collection.

For example, the first information transmitted from the communication system M to the in-vehicle communication device 5 includes at least key information, information relating to installation of the power transmission device 2, and the like. The key information, for example, is information that is generated while being updated with a predetermined period such that the information is different for each authenticated vehicle V passing through a predetermined power transmission section TS to be described below (in other words, each vehicle permitted to execute power transmission). The key information is information that is required for the power transmission device 2 to authenticate the power reception device 4 of the vehicle V and start power transmission. The information relating to installation of the power transmission device 2, for example, is information such as installation intervals of a plurality of power transmission units 8, a distance from the road-side communicator Ma, and the like to be described below.

For example, when information required for billing and payment of power transmission is acquired from the in-vehicle communication device 5, the communication system M checks whether or not electronic payment can be performed. When it is checked that electronic payment can be performed, the communication system M transmits permission information representing permission of power transmission and key information required for starting power transmission to the in-vehicle communication device 5. In a case in which key information is transmitted to the in-vehicle communication device 5, the communication system M transmits information of a combination of the same key information and information relating to power transmission received from the in-vehicle communication device 5 to the power transmission-side control device 9 to be described below.

The power supply unit 6, for example, is connected to a plurality of transmission power converting units 7. The power supply unit 6, for example, includes an AC power supply such as a commercial power supply, an AC-DC converter converting AC power into DC power, and a capacitor for smoothing electric power. The power supply unit 6 converts AC power supplied from the AC power supply into DC power using the AC-DC converter.

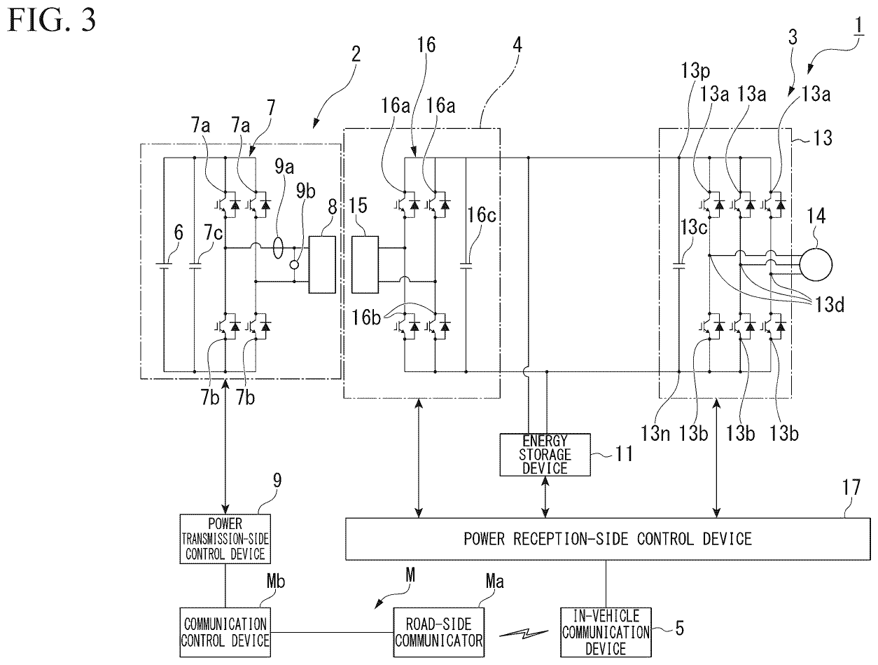

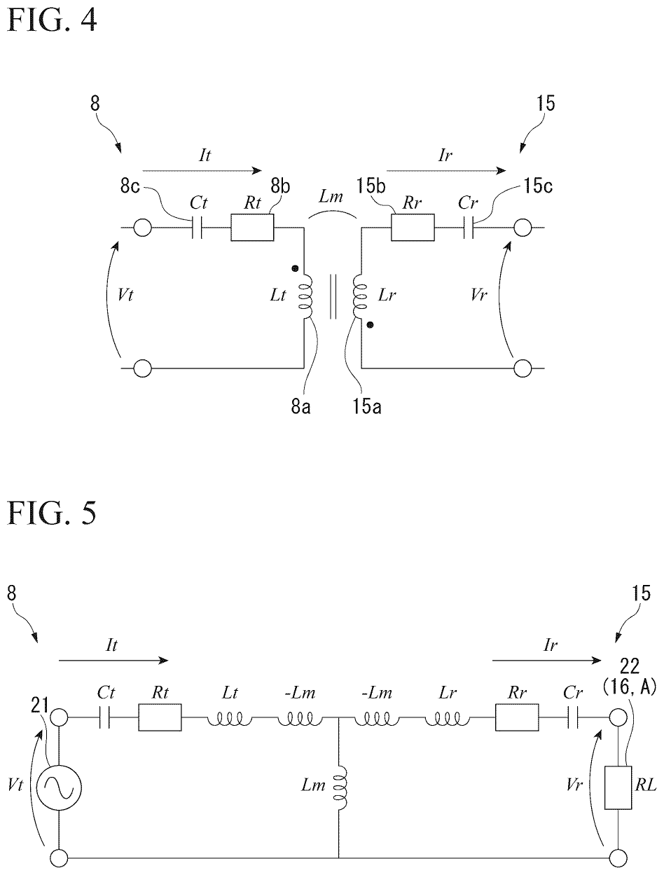

FIG. 3 is a diagram illustrating details of a configuration of the contactless power transmission system 1 according to the embodiment. FIG. 4 is a diagram illustrating a configuration of the power transmission unit 8 and the power reception unit 15 of the contactless power transmission system 1 according to the embodiment.

As illustrated in FIG. 3, the transmission power converting unit 7, for example, includes an inverter that converts DC power into AC power. The inverter of the transmission power converting unit 7, for example, includes a first bridge circuit formed using a plurality of switching elements that are bridge-connected in two phases and a rectification element and a capacitor for resonance adjustment. Each switching element, for example, is a transistor such as a metal oxide semi-conductor field effect transistor (MOSFET) of silicon carbide (SiC). The plurality of switching elements are transistors 7a and 7b of a high-side arm and a low-side arm forming a pair in each phase. The rectification element, for example, is a freewheeling diode connected to the transistors 7a and 7b in parallel. A capacitor 7c for voltage smoothing is connected to the first bridge circuit in parallel. The transmission power converting unit 7, for example, includes a sensor such as a current sensor that detects a current of DC power.

The power transmission unit 8 is connected to an AC terminal of the first bridge circuit of the transmission power converting unit 7. The power transmission unit 8, for example, sends electric power using changes of a high-frequency magnetic field through magnetic coupling such as magnetic resonance or electromagnetic induction. As illustrated in FIGS. 3 and 4, for example, the power transmission unit 8 includes a resonant circuit formed using a primary-side coil 8a, a primary-side resistor 8b, and a primary-side capacitor 8c that are connected in series. The power transmission unit 8, for example, includes sensors such as a current sensor 9a detecting a current (a power transmission-side current) It flowing through the resonant circuit, a voltage sensor 9b detecting a voltage (a power transmission-side voltage) Vt of the resonant circuit, and the like.

The power transmission-side control device 9 integrally controls the power transmission device 2. The power transmission-side control device 9, for example, is a software functional unit that functions by executing a predetermined program using a processor such as a central processing unit (CPU). The software functional unit is an ECU that includes a processor such as a CPU, a read only memory (ROM) storing a program, a random access memory (RAM) temporarily storing data, and an electronic circuit such as a timer. At least a part of the power transmission-side control device 9 may be an integrated circuit such as a large scale integration (LSI).

In power transmission control at the time of power transmission between the power transmission device 2 and the power reception device 4, the power transmission-side control device 9, for example, independently controls conduction switching operations of the plurality of transmission power converting units 7. The power transmission-side control device 9, for example, executes independent control for the plurality of transmission power converting units 7 such that a plurality of sets of the transmission power converting unit 7 and the power transmission unit 8 execute individual power transmission at appropriate timings including a simultaneous timing for the power reception devices 4 of mutually-different vehicles V.

The power transmission-side control device 9, for example, generates a control signal representing timings at which each switching element is driven to be on (conduction) and off (cutoff) for each of the plurality of transmission power converting units 7 and generates a gate signal for actually driving each switching element to be on and off on the basis of the control signal.

For example, by controlling switching of on (conduction) and off (cutoff) of each switching element in accordance with a drive frequency set in advance or information of a requested frequency received from the power reception device 4 for each of the plurality of transmission power converting units 7, the power transmission-side control device 9 performs power transmission for the power reception device 4 of a vehicle V corresponding to each transmission power converting unit 7 and each power transmission unit 8.

For example, prior to start of power transmission between the power transmission device 2 and the power reception device 4, the power transmission-side control device 9 controls communication between the power transmission device 2 and the power reception device 4 using the primary-side coil 8a and the secondary-side coil 15a.

For example, when the information of the combination of key information and information relating to power transmission is received from the communication system M, the power transmission-side control device 9 perceives that the same key information has been transmitted to the in-vehicle communication device 5 of the vehicle V and transitions the power transmission device 2 from a stop state to a reception standby state. The stop state of the power transmission device 2 is a state in which a switching operation in each transmission power converting unit 7 is stopped such as maintaining of each switching element of each of the plurality of transmission power converting unit 7 to be off (cutoff). The reception standby state of the power transmission device 2 is a state in which transmission of information from the power reception device 4 of the vehicle V is detected. The reception standby state of the power transmission device 2, for example, is a short-circuit state of each transmission power converting unit 7.

In the short-circuit state of each transmission power converting unit 7, by setting the transistor 7b of the low-side arm of each phase to on, the power transmission-side control device 9 causes the primary-side coil 8a to be short-circuited. In accordance with this, when the power transmission device 2 of the primary side is seen from the power reception device 4 of the secondary side, the impedance of the primary side has a very large value, if a magnetic field is generated by the secondary-side coil 15a of the power reception device 4 at the time of transmitting a ping to be described below, communication from the power reception device 4 is detected in accordance with a voltage induced in the primary-side coil 8a of the power transmission device 2. By demodulating a voltage detected at the time of transmitting a ping, the power transmission-side control device 9 acquires information superimposed in the ping signal.

For example, when key information is received in accordance with a ping signal transmitted from the secondary-side coil 15a of the power reception device 4 to the appropriate primary-side coil 8a of the power transmission device 2, the power transmission-side control device 9 performs collation of the key information on the basis of the information of the combination of the key information and the information relating to power transmission received from the communication system M in advance. In a case in which the key information received from the communication system M and the key information received from the power reception device 4 match each other, the power transmission-side control device 9 transitions the transmission power converting unit 7 corresponding to the primary-side coil 8a that has received the key information from the reception standby state to a search state (a search mode). In the search state of the transmission power converting unit 7, the power transmission-side control device 9, for example, estimates a coupling coefficient k of the primary-side coil 8a and the secondary-side coil 15a on the basis of current detection in the power transmission unit 8 while outputting a voltage pulse to the primary-side coil 8a in a conduction switching operation according to switching in the transmission power converting unit 7.

In the search state of each transmission power converting unit 7, the power transmission-side control device 9 acquires mutual inductance Lm and a coupling coefficient k of the primary-side coil 8a and the secondary-side coil 15a on the basis of detection values output from the current sensor 9a and the voltage sensor 9b of the power transmission unit 8.

FIG. 5 is a diagram illustrating a T-type equivalent circuit of the contactless power transmission system 1 according to the embodiment.

As illustrated in FIG. 5, the T-type equivalent circuit of the contactless power transmission system 1, for example, is described using a voltage Vt of the AC voltage source 21, a capacitance Ct of the power transmission unit 8, an internal resistance value Rt, self-inductance Lt and a current It, mutual inductance Lm, a capacitance Cr of the power reception unit 15, an internal resistance value Rr, self-inductance Lr and a current Ir, and a voltage Vr and a load resistance value RL of the load resistor 22.

The load resistor 22, for example, corresponds to a reception power converting unit 16 to be described below and a load resistor A connected between DC terminals (a positive electrode and a negative electrode) of the reception power converting unit 16. The load resistor A, for example, is the driving control device 3 and the like.

As in a voltage equation represented in the following Numeric Equation (1), the current It of the power transmission unit 8 and the current Ir and the voltage Vr of the power reception unit 15 are described using the frequency ω₀ of power transmission, the mutual inductance Lm, the resistance values Rt, Rr, and RL, and the voltage Vt of the power transmission unit 8.

$$\begin{matrix}It = \frac{Rr + RL}{{( {ω}_{0} Lm )}^{2} + Rt ( Rr + RL )} Vt \\ Ir = \frac{{ω}_{0} Lm}{{( {ω}_{0} Lm )}^{2} + Rt ( Rr + RL )} Vt \\ Vr = \frac{{ω}_{0} \cdot Lm \cdot RL}{{( {ω}_{0} Lm )}^{2} + Rt ( Rr + RL )} Vt\end{matrix} \} \qquad ( 1 )$$

For example, although a state in which the efficiency of power transmission is good is a state in which the voltage Vt of the power transmission unit 8 and the voltage Vr of the power reception unit 15 are caused to be the same, the voltage Vr of the power reception unit 15 can be acquired through ping communication, and thus the voltage Vt of the power transmission unit 8 and the voltage Vr of the power reception unit 15, as represented in the following Numeric Equation (2), are described using a predetermined coefficient a.

$$Vt = a \cdot Vr \qquad ( 2 )$$

As represented in the following Numeric Equation (3), the load resistance value RL is described using the frequency ω₀ of power transmission, the mutual inductance Lm, and the internal resistance values Rt and Rr on the basis of Numeric Equation (1) and Numeric Equation (2) described above.

$$RL = \frac{{( {ω}_{0} Lm )}^{2} + Rt \cdot Rr}{a \cdot {ω}_{0} Lm - Rt} \qquad ( 3 )$$

On the basis of the above-described Numeric Equation (1) and the above-described Numeric Equation (3), the mutual inductance Lm is acquired using the internal resistance values Rt and Rr, which are known, the frequency ω₀ and the predetermined coefficient a of power transmission, detection values output from the sensors 9a and 9b of the power transmission unit 8, for example, peak-to-peak values (PP values), and the like. The coupling coefficient k is acquired on the basis of the mutual inductance Lm and self-inductance of each of the primary-side coil 8a and the secondary-side coil 31a which is known.

For example, in a case in which the coupling coefficient k estimated in the search state of each transmission power converting unit 7 has reached a predetermined value ka or more within a predetermined time, the power transmission-side control device 9 transitions each transmission power converting unit 7 from the search state to a power transmission control state. The predetermined value ka, for example, is a value corresponding to a predetermined value (for example, 80% or the like) of the efficiency (for example, overall efficiency or the like) of power transmission. The power transmission control state of each transmission power converting unit 7, for example, is a state in which power transmission with a requested power and a requested frequency of the power reception device 4 is controlled.

On the other hand, for example, in a case in which the coupling coefficient k estimated in the search state of each transmission power converting unit 7 has not reached the predetermined value ka or more within a predetermined time, the power transmission-side control device 9 returns each transmission power converting unit 7 from the search state to the reception standby state.

Details of the control operation of the power transmission-side control device 9 will be described below.

As illustrated in FIGS. 1, 2, and 3, the driving control device 3 of the vehicle V, for example, includes an energy storage device 11, a power converting unit 13, and a rotating electric machine 14. The power reception device 4 of the vehicle V, for example, includes a power reception unit 15 and a reception power converting unit 16. The driving control device 3 and the power reception device 4, for example, include a common power reception-side control device 17.

The energy storage device 11 is connected to the power converting unit 13 and the reception power converting unit 16 to be described below. The energy storage device 11 is charged using electric power that is contactlessly transmitted from the power transmission device 2 disposed outside of the vehicle V. The energy storage device 11 transmits/receives electric power to/from the rotating electric machine 14 through the power converting unit 13.

The energy storage device 11, for example, includes a battery, a current sensor detecting a current of the battery, and a voltage sensor detecting a voltage of the battery. The battery is, for example, a secondary battery such as a lead-acid battery, a lithium-ion battery, a sodium-ion battery, a nickel hydride battery, or an all-solid-state battery, a capacitor such as an electric double-layer capacitor, a hybrid battery acquired by combining a secondary battery and a capacitor, or the like.

The power converting unit 13 is connected to the rotating electric machine 14. The power converting unit 13, for example, includes a second element module that performs conversion between DC power and AC power and a capacitor for voltage smoothing. The second element module, for example, includes a second bridge circuit formed using a plurality of switching elements that are bridge-connected in three phases and a rectification element. Each switching element, for example, is a transistor such as an insulated gate bipolar transistor (IGBT) or a SiC MOSFET. The plurality of switching elements are transistors 13a and 13b of a high-side arm and a low-side arm forming a pair in each phase. The rectification element, for example, is a flyback diode connected to each of the transistors 13a and 13b in parallel. The capacitor 13c for voltage smoothing is connected to the second bridge circuit in parallel.

The second element module controls the operation of the rotating electric machine 14 using transmission and reception of electric power. For example, at the time of a powering operation of the rotating electric machine 14, the second element module converts a DC power input from positive and negative DC terminals 13p and 13n into a three-phase AC power and supplies the three-phase AC power from a three-phase AC terminal 13d to the rotating electric machine 14. The second element module generates a rotational driving force by sequentially switching conduction for three-phase stator windings of the rotating electric machine 14.

For example, at the time of a regenerative operation of the rotating electric machine 14, the second element module converts three-phase AC power input from the three-phase stator windings into DC power by driving the switching elements of respective phases synchronized with the rotation of the rotating electric machine 14 to be on (conduction) and off (cutoff). The second element module can supply DC power converted from the three-phase AC power to the energy storage device 11.

The rotating electric machine 14, for example, is a three-phase AC brushless DC motor disposed for traveling driving of the vehicle V. The rotating electric machine 14 includes a rotor having permanent magnets for field excitation and a stator having three-phase stator windings generating a rotary magnetic field rotating the rotor. The three-phase stator windings are connected to the three-phase AC terminal 13d of the power converting unit 13.

The rotating electric machine 14 generates a rotation driving force by performing a powering operation using electric power supplied from the power converting unit 13. For example, in the case of being connected to vehicle wheels of the vehicle V, the rotating electric machine 14 generates a traveling driving force by performing a powering operation using electric power supplied from the power converting unit 13. The rotating electric machine 14 may generate electric power by performing a regenerative operation using a rotational moving force input from the vehicle wheel-side of the vehicle V. In the case of being connected to an internal combustion engine of the vehicle V, the rotating electric machine 14 may generate electric power using power of the internal combustion engine.

The power reception unit 15 is connected to an AC terminal of a third bridge circuit of the reception power converting unit 16 to be described below. The power reception unit 15, for example, receives electric power in accordance with changes of a high-frequency magnetic field transmitted from the power transmission unit 8 using magnetic coupling such as magnetic resonance or electromagnetic induction. As illustrated in FIG. 4, the power reception unit 15, for example, includes a resonant circuit formed using a secondary-side coil 15a, a secondary-side resistor 15b, and a secondary-side capacitor 15c connected in series. The power reception unit 15, for example, includes sensors such as a current sensor detecting a current (a power reception-side current) Ir flowing through the resonant circuit, a voltage sensor detecting a voltage (a power reception-side voltage) Vr of the resonant circuit, and the like.

The reception power converting unit 16 illustrated in FIGS. 1, 2, and 3 is connected to the power converting unit 13. The reception power converting unit 16 includes a power factor correction (PFC) circuit of a so-called full bridgeless type (or a bridgeless and totem-pole type) that converts AC power into DC power. The so-called bridgeless PFC circuit is a PFC circuit not including a bridge rectifier acquired by forming bridge-connection of a plurality of diodes, and the so-called totem-pole PFC circuit is a PFC circuit including one pair of switching elements of the same conduction type connected in series in the same direction (totem-pole connection).

The reception power converting unit 16, for example, includes a third bridge circuit formed using a plurality of switching elements that are bridge-connected in two phases and a rectification element and a capacitor for voltage smoothing. Each switching element, for example, is a transistor such as a SiC MOSFET. The plurality of switching elements are transistors 16a and 16b of a high-side arm and a low-side arm forming a pair in each phase. The rectification element, for example, is a flyback diode that is connected to the transistors 16a and 16b in parallel. The capacitor 16c for voltage smoothing is connected to the third bridge circuit in parallel. The reception power converting unit 16, for example, includes a sensor such as a current sensor that detects a current of DC power.

For example, the power reception device 4 including the power reception unit 15 and the reception power converting unit 16 controls on/off (conduction/cutoff) switching of each switching element of the reception power converting unit 16 in accordance with information of a frequency of power transmission using the power transmission device 2, thereby receiving electric power transmitted from the power transmission device 2.

The power reception-side control device 17, for example, integrally controls the driving control device 3, the power reception device 4, and the in-vehicle communication device 5 of the vehicle V. The power reception-side control device 17, for example, is a software functional unit that functions by executing a predetermined program using a processor such as a central processing unit (CPU). The software functional unit is an ECU that includes a processor such as a CPU, a read only memory (ROM) storing a program, a random access memory (RAM) temporarily storing data, and an electronic circuit such as a timer. At least a part of the power reception-side control device 17 may be an integrated circuit such as a large scale integration (LSI).

In power reception control at the time of power transmission between the power transmission device 2 and the power reception device 4, the power reception-side control device 17, for example, controls a conduction switching operation of each of the driving control device 3 and the power reception device 4. The power reception-side control device 17, for example, generates a control signal representing timings at which each switching element of the driving control device 3 and the power reception device 4 is driven to on (conduction) and off (cutoff) and generates a gate signal for actually driving each switching element to on and off on the basis of the control signal.

For example, by controlling switching of each switching element of the power reception device 4, the power reception-side control device 17 performs power factor correction of an input voltage and an input current while rectifying AC power received from the power transmission device 2 into DC power.

For example, the power reception-side control device 17 controls an output according to a target output by performing a synchronous rectification operation synchronously driving the plurality of switching elements of the power reception device 4 to on and off and a short-circuit operation forming a short circuit of the secondary-side coil 15a.

For example, the power reception-side control device 17 controls a synchronous rectification operation in accordance with a magnitude and a phase of a current generated in the power reception unit 15 using electric power transmitted from the power transmission device 2, that is, the current Ir flowing through the secondary-side coil 15a.

The power reception-side control device 17 controls the plurality of switching elements of the reception power converting unit 16 using soft switching of so-called zero voltage switching (ZVS). In zero voltage switching (ZVS), each switching element executes turning-on (change from an off state to an on state) after a voltage between both ends thereof becomes zero in accordance with discharge of output capacitance (parasitic capacitance) in an off state of a dead time period of each phase.

For example, the power reception-side control device 17 controls a short-circuit operation by causing only the low-side arm of each phase to be on while causing the synchronous rectification operation of zero voltage switching (ZVS) to be continued in the high-side arm of each phase of the reception power converting unit 16. By forming a short circuit of the secondary-side coil 15a, the power reception-side control device 17 increases the impedance of the secondary side of a case in which the power reception device 4 of the secondary side is seen from the power transmission device 2 of the primary side and restricts the current of the primary side (power transmission-side current: current It flowing through the primary-side coil 8a). By controlling the current It of the power transmission device 2 of the primary side using the power reception device 4 of the secondary side, the power reception-side control device 17 executes independent power control such as power transmission stop on the power reception device 4 side.

For example, prior to start of power transmission between the power transmission device 2 and the power reception device 4, the power reception-side control device 17 controls communication between the power transmission device 2 and the power reception device 4 using the primary-side coil 8a and the secondary-side coil 15a.

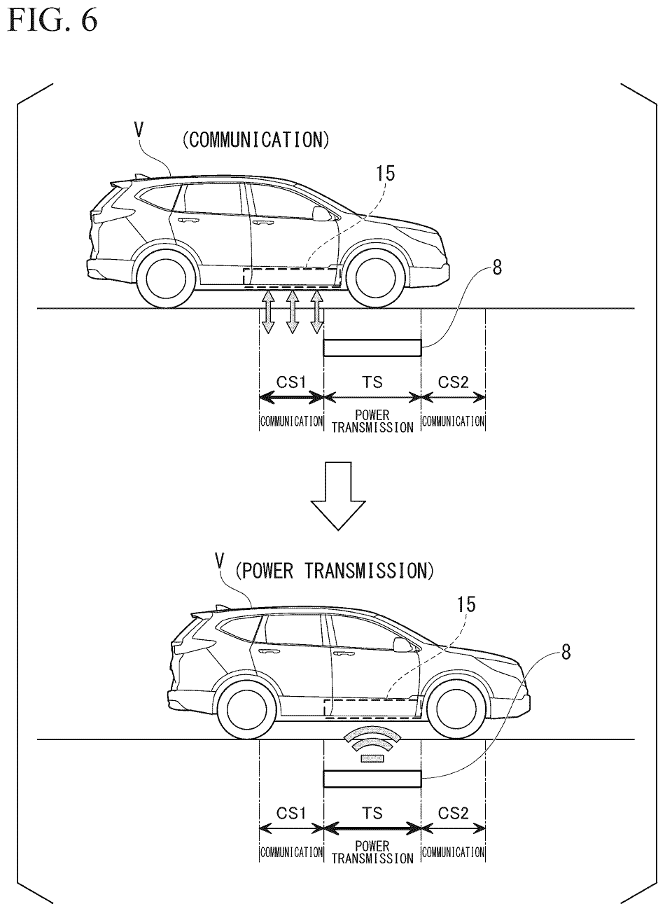

FIG. 6 is a diagram illustrating an example of operations of communication and power transmission accompanied with movement of a vehicle V in the embodiment.

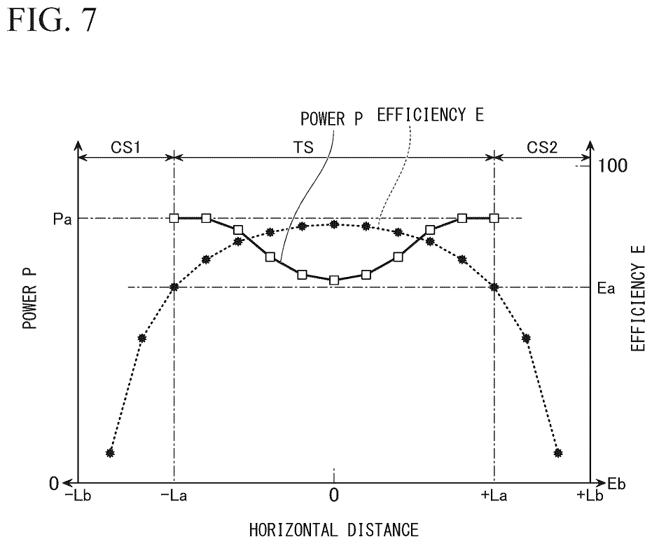

FIG. 7 is a graph diagram illustrating an example of a correspondence relation between electric power and efficiency according to a horizontal distance (a relative movement amount between the primary-side coil 8a and the secondary-side coil 15a in a direction parallel to a road surface) in the contactless power transmission system 1 according to the embodiment.

As illustrated in FIGS. 6 and 7, the power reception-side control device 17, for example, sets a section in which a degree of coupling between the primary-side coil 8a of the power transmission device 2 and the secondary-side coil 15a of the power reception device 4 is a predetermined level or more near the power transmission device 2 as a coupling section. In the coupling section, the power reception-side control device 17 sets communication sections CS (a first communication section CS1 and a second communication section CS2) for communication using the primary-side coil 8a and the secondary-side coil 15a and a power transmission section TS for power transmission.

The power reception-side control device 17, for example, sets a coupling section in which a degree of coupling between the primary-side coil 8a and the secondary-side coil 15a is a predetermined level or more as a section in which the efficiency E of power transmission is a predetermined value (zero or the like) or more. The power reception-side control device 17 sets a section in which the efficiency E of power transmission is a first predetermined value Ea (for example, 80% or the like) or more, and a relative horizontal distance between the primary-side coil 8a and the secondary-side coil 15a is a first predetermined distance La or less in the coupling section as a power transmission section TS in which a degree of coupling between the primary-side coil 8a and the secondary-side coil 15a is relatively large. The power reception-side control device 17 sets a section in which the efficiency of power transmission is less than the first predetermined value Ea and a second predetermined value Eb (for example, 0% or the like) or more, and a relative horizontal distance between the primary-side coil 8a and the secondary-side coil 15a is larger than the first predetermined distance La and a second predetermined distance Lb or less in the coupling section as a communication section CS in which a degree of coupling between the primary-side coil 8a and the secondary-side coil 15a is relatively small. The communication section CS, for example, is a first communication section CS1 and a second communication section CS2 that are set before/after the power transmission section TS along a movement direction of the vehicle V. A state in which the horizontal distance is zero, for example, is a state in which center axial lines of the primary-side coil 8a and the secondary-side coil 15a are the same. Power P transmitted in the power transmission section TS, for example, is regulated to be an appropriate requested power Pa or less.

For example, when key information and information relating to installation of the power transmission device 2 are received in accordance with communication between the road-side communicator Ma of the communication system M and the in-vehicle communication device 5 before the vehicle V reaches the coupling section, the power reception-side control device 17 sets a communication timing in the communication section CS. The power reception-side control device 17, for example, sets a communication timing in an initial communication section CS, that is, the first communication section CS1 for each of the plurality of power transmission units 8 in accordance with information such as an installation interval of the plurality of power transmission units 8 and a distance from the road-side communicator Ma and a traveling state (that is, the moving state of the power reception device 4) of the vehicle V.

For example, when the power reception unit 15 reaches the first communication section CS1 of an appropriate power transmission unit 8, the power reception-side control device 17 transitions the power reception device 4 from a short-circuit state to a transmission state. The short-circuit state of the power reception device 4 is a state in which the secondary-side coil 15a forms a short circuit by setting the transistor 16b of the low-side arm of each phase of the reception power converting unit 16 to on. The transmission state of the power reception device 4 is a state in which second information is transmitted using a so-called ping signal from the secondary-side coil 15a to the transmission power converting unit 7 in the reception standby state and the primary-side coil 8a. The power reception-side control device 17, for example, performs communication using a voltage induced in the primary-side coil 8a of the power transmission device 2 in accordance with a magnetic field generated in the secondary-side coil 15a in a conduction switching operation according to switching in the reception power converting unit 16. For example, by switching a carrier wave for contactlessly transmitting power from the secondary-side coil 15a to the primary-side coil 8a with a predetermined duty ratio, the power reception-side control device 17 generates digital signals of two levels of so-called dominant and recessive levels to execute ping transmission. The predetermined duty ratio, for example, is about 50% from a predetermined minimum. For example, the power reception-side control device 17 may transmit second information using amplitude modulation of a carrier wave according to change of the duty ratio of switching.

The power reception-side control device 17, for example, performs ping transmission with a predetermined period such as several tens of s to several ms and transmits information relating to power transmission in the power transmission section TS from the secondary-side coil 15a to the primary-side coil 8a as second information. The information relating to power transmission, for example, is key information acquired by the in-vehicle communication device 5 from the road-side communicator Ma, a requested frequency of power transmission, a target output (power consumption) for fail-safe, information relating to various abnormalities, and the like.

The requested power of power transmission is a target value of power received from the power transmission device 2 by the power reception device 4 and, for example, is set in accordance with a target drive force of the vehicle V or the rotating electric machine 14, power consumption of various auxiliary devices connected to the energy storage device 11, a remaining capacity (a state of charge (SOC)) of the energy storage device 11, and the like.

The requested frequency of power transmission is a frequency requested for power transmission of the power transmission device 2 and is set in accordance with requested power. The requested frequency, for example, is set to suppress reductions in the efficiency and output (power) of power transmission on the basis of a minimum ground clearance of the vehicle V, a mounting layout of the power reception device 4 in the vehicle V, and the like relating to a distance between the primary-side coil 8a and the secondary-side coil 15a. The requested frequency, for example, may be set in accordance with a power transmission state between the power transmission device 2 and the power reception device 4.

For example, when at least a predetermined number of times (one time or the like) of ping transmission is completed, the power reception-side control device 17 transitions the power reception device 4 from the transmission state to a power reception standby state. The power reception standby state of the power reception device 4 is a state in which power transmitted from the transmission power converting unit 7 of the search state and the primary-side coil 8a is received. For example, in a case in which reception power detected in the power reception standby state reaches a predetermined power or more within a predetermined time, in other words, in a case in which the power reception unit 15 reaches the power transmission section TS, the power reception-side control device 17 transitions the power reception device 4 from the power reception standby state to a reception power control state. The predetermined power, for example, is a predetermined value (for example, 80% or the like) of the efficiency (for example, overall efficiency or the like) of power transmission, that is, a value corresponding to the predetermined value ka of the coupling coefficient k estimated by the power transmission-side control device 9.

On the other hand, for example, in a case in which the reception power detected in the power reception standby state has not reached a predetermined power or more within a predetermined time, in other words, in a case in which the power reception unit 15 has not reached the power transmission section TS, the power reception-side control device 17 returns the power reception device 4 from the power reception standby state to the transmission state.

For example, in a case in which the power reception unit 15 is present in the second communication section CS2, the power reception-side control device 17 may transmit information representing stop of each of power transmission in the power transmission section TS and communication in the communication section CS from the secondary-side coil 15a to the primary-side coil 8a.

Details of the control operation of the power reception-side control device 17 will be described below.

Hereinafter, processes executed by the power transmission-side control device 9 and the power reception-side control device 17 will be described as operations of the contactless power transmission system 1.

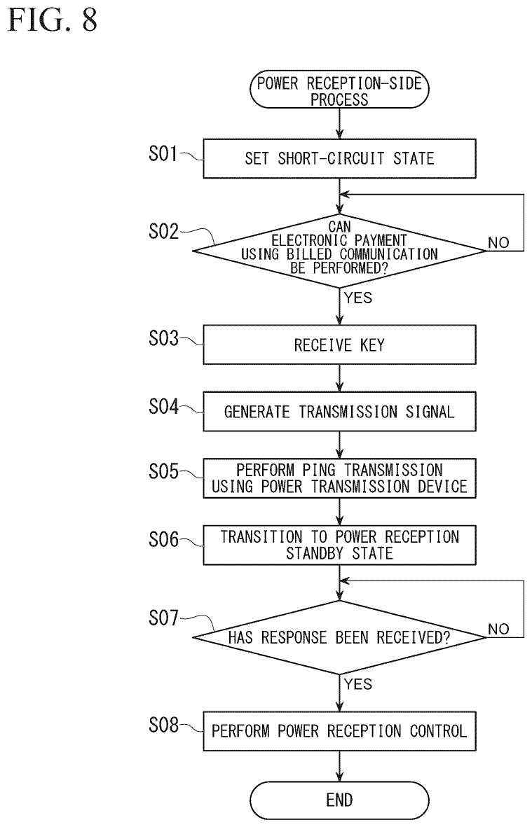

FIG. 8 is a flowchart illustrating a power reception-side process executed by the power reception-side control device 17 of the contactless power transmission system 1 according to the embodiment.

First, in Step S01 illustrated in FIG. 8, the power reception-side control device 17 sets the power reception device 4 to a short-circuit state.

Next, in Step S02, the power reception-side control device 17 determines whether or not electronic payment for power transmission from the power transmission device 2 to the vehicle V can be performed using transmission/reception (billed communication) of information using radio communication between the road-side communicator Ma of the communication system M and the in-vehicle communication device 5. In a case in which this determination result is “No”, the power reception-side control device 17 repeats the process of Step S02. On the other hand, in a case in which this determination result is “Yes”, the power reception-side control device 17 causes the process to proceed to Step S03.

Then, in Step S03, the power reception-side control device 17 acquires key information required for start of power transmission from the road-side communicator Ma through the in-vehicle communication device 5.

Next, in Step S04, for example, when the power reception unit 15 reaches the first communication section CS1 of an appropriate power transmission unit 8, the power reception-side control device 17 transitions the power reception device 4 from the short-circuit state to the transmission state. The power reception-side control device 17 generates a signal for ping transmission from the secondary-side coil 15a of the power reception device 4 to the primary-side coil 8a of an appropriate power transmission unit 8 of the power transmission device 2.

Next, in Step S05, the power reception-side control device 17 executes ping transmission with a predetermined period in the first communication section CS1 for the primary-side coil 8a of an appropriate power transmission unit 8 of the power transmission device 2.

Next, in Step S06, when at least a predetermined number of times (one time or the like) of ping transmission is completed, the power reception-side control device 17 transitions the power reception device 4 from the transmission state to the power reception standby state.

Next, in Step S07, the power reception-side control device 17 determines whether or not a response signal from the power transmission unit 8 for ping transmission has been received. In a case in which this determination result is “No”, the power reception-side control device 17 repeats the process of Step S07. On the other hand, in a case in which this determination result is “Yes”, the power reception-side control device 17 causes the process to proceed to Step S08.

Next, in Step S08, the power reception-side control device 17 executes power reception control for power transmission from the power transmission device 2 in the power transmission section TS. Then, the power reception-side control device 17 causes the process to end.

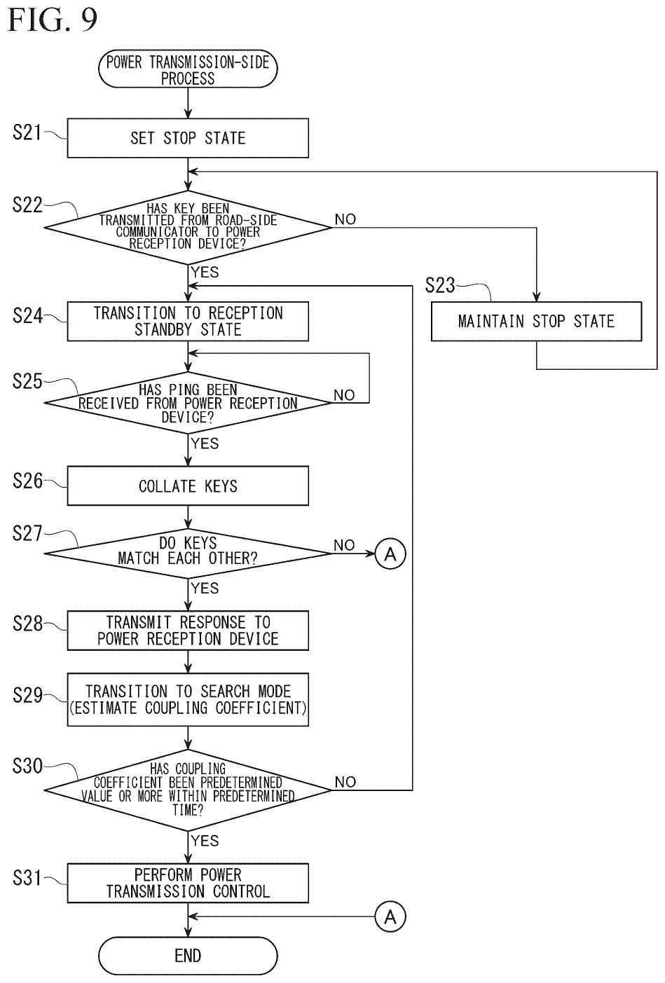

FIG. 9 is a flowchart illustrating a power transmission-side process executed by the power transmission-side control device 9 of the contactless power transmission system 1 according to the embodiment.

First, in Step S21 represented in FIG. 9, the power transmission-side control device 9 sets the power transmission device 2 to a stop state.

Next, in Step S22, the power transmission-side control device 9 determines whether or not key information has been transmitted from the road-side communicator Ma to the power reception device 4. In a case in which this determination result is “No”, the power transmission-side control device 9 causes the process to proceed to Step S23. On the other hand, in a case in which this determination result is “Yes”, the power transmission-side control device 9 causes the process to proceed to Step S24.

Then, in Step S23, the power transmission-side control device 9 maintains the stop state of the power transmission device 2 and returns the process to Step S22.

Then, in Step S24, the power transmission-side control device 9 transitions the power transmission device 2 from the stop state to the reception standby state.

Next, in Step S25, the power transmission-side control device 9 determines whether or not a ping signal transmitted from the secondary-side coil 15a to the primary-side coil 8a has been received in the first communication section CS1 of one power transmission unit 8. In a case in which this determination result is “No”, the power transmission-side control device 9 repeats the process of Step S25. On the other hand, in a case in which this determination result is “Yes”, the power transmission-side control device 9 causes the process to proceed to Step S26.

Next, in Step S26, the power transmission-side control device 9 collates key information that has been received from the communication control device Mb in advance with key information that has been received from the secondary-side coil 15a of the power reception device 4 by the primary-side coil 8a.

Next, in Step S27, the power transmission-side control device 9 determines whether or not the key information received from the communication system M (that is, the same key information as the key information transmitted from the communication system M to the in-vehicle communication device 5) and the key information received from the secondary-side coil 15a of the power reception device 4 by the primary-side coil 8a match each other. In a case in which this determination result is “Yes”, in other words, in a case in which pairing of the secondary-side coil 15a of the power reception device 4 and the primary-side coil 8a of the power transmission unit 8 that has received a ping signal transmitted from the power reception device 4 has been formed, the power transmission-side control device 9 causes the process to proceed to Step S28. On the other hand, in a case in which this determination result is “No”, the power transmission-side control device 9 ends the process.

Next, in Step S28, the power transmission-side control device 9 transmits a response signal for ping transmission from the power reception device 4 to the power reception device 4 through the primary-side coil 8a and the secondary-side coil 15a of which pairing has been formed.

Next, in Step S29, the power transmission-side control device 9 transitions the transmission power converting unit 7 corresponding to the primary-side coil 8a of which paring has been formed from the reception standby state to the search state (search mode). In the search state of each transmission power converting unit 7, the power transmission-side control device 9 acquires a mutual inductance Lm and a coupling coefficient k between the primary-side coil 8a and the secondary-side coil 15a of which paring has been formed on the basis of the above-described Numeric Equation (1), the above-described Numeric Equation (3), and detection values output from the current sensor 9a and the voltage sensor 9b of the power transmission unit 8.

Next, in Step S30, the power transmission-side control device 9 determines whether or not the coupling coefficient k estimated in the search state of the transmission power converting unit 7 has reached a predetermined value (a predetermined threshold) ka or more within a predetermined time. In a case in which this determination result is “No”, the power transmission-side control device 9 returns the process to Step S24. On the other hand, in a case in which this determination result is “Yes”, the power transmission-side control device 9 causes the process to proceed to Step S31.

Then, in Step S31, the power transmission-side control device 9 executes power transmission control for power transmission using the transmission power converting unit 7 and the power transmission unit 8 in the power transmission section TS. Then, the power transmission-side control device 9 ends the process.

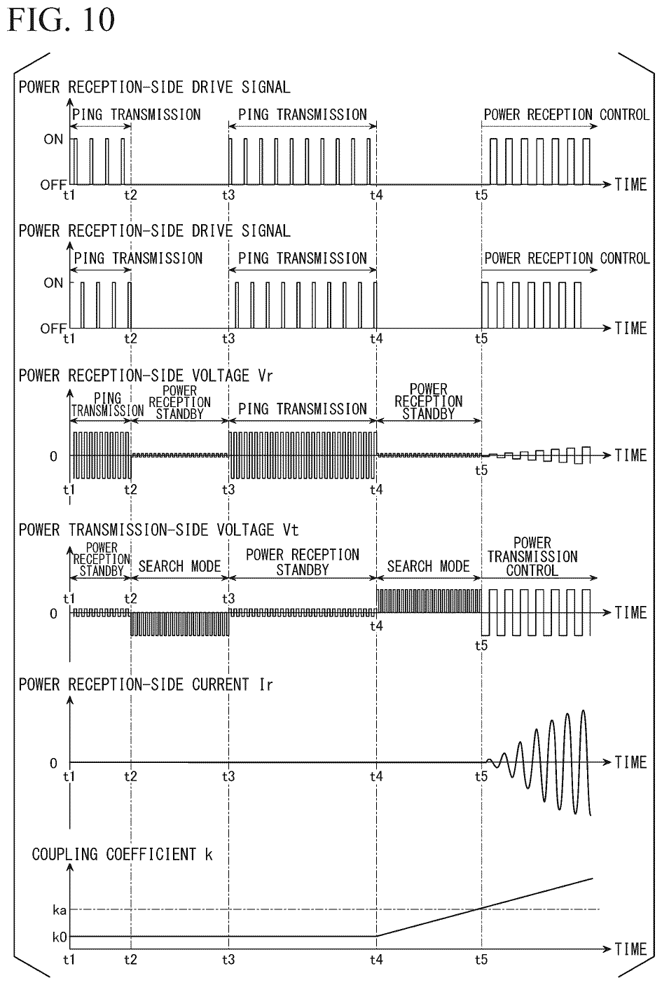

FIG. 10 is a diagram illustrating one example of a correspondence relation of a power reception-side drive signal, a power reception-side voltage Vr, a power transmission-side voltage Vt, a power reception-side current Ir, and a coupling coefficient k at the time of communication between the primary-side coil 8a and the secondary-side coil 15a prior to start of power transmission in the contactless power transmission system 1 according to the embodiment. The power reception-side drive signal is a gate signal that drives each switching element of the reception power converting unit 16. Before a time t1 represented in FIG. 10, when information of a combination of key information and information relating to power transmission is received from the communication system M, the power transmission-side control device 9 transitions the power transmission device 2 from the stop state to the reception standby state.

At the time t1 at which the power reception unit 15 reaches the first communication section CS1 of an appropriate power transmission unit 8, the power reception-side control device 17 transitions the power reception device 4 from the short-circuit state to the transmission state. The power reception-side control device 17 executes at least a predetermined number of times (one time or the like) of ping transmission over a period up to a time t2 and transitions the power reception device 4 from the transmission state to the power reception standby state after completion of the ping transmission.

When key information is received in accordance with a ping signal, the power transmission-side control device 9 performs collation of key information on the basis of key information received from the communication system M in advance. In a case in which the key information received from the communication system M and the key information received from the power reception device 4 match each other, the power transmission-side control device 9 transitions the transmission power converting unit 7 corresponding to the primary-side coil 8a that has received the key information from the reception standby state to the search state (search mode).

The power transmission-side control device 9 estimates the coupling coefficient k between the primary-side coil 8a and the secondary-side coil 15a on the basis of current detection in the power transmission unit 8 while outputting a voltage pulse to the primary-side coil 8a in a conduction switching operation according to switching of the transmission power converting unit 7 in the search state (search mode) over the time t2 to the time t3. For example, in a case in which the coupling coefficient k has not reached the predetermined value ka or more within a predetermined time without changing from an appropriate initial value kO, the power transmission-side control device 9 returns the transmission power converting unit 7 from the search state (search mode) to the reception standby state at a time t3.

In a case in which reception power detected in the power reception standby state has not reached a predetermined power or more within a predetermined time in accordance with no increase in the coupling coefficient k, the power reception-side control device 17 returns the power reception device 4 from the power reception standby state to the transmission state at the time t3.

The power reception-side control device 17 executes at least a predetermined number of times (one time or the like) of ping transmission over a period from the time t3 to the time t4 again and transitions the power reception device 4 from the transmission state to the power reception standby state after completion of the ping transmission.

The power transmission-side control device 9 performs collation of the key information received from the communication system M in advance with the key information acquired from a ping signal again. In a case in which the key information matches, the power transmission-side control device 9 transitions the transmission power converting unit 7 corresponding to the primary-side coil 8a that has received the key information from the reception standby state to the search state (search mode).

The power transmission-side control device 9 estimates the coupling coefficient k between the primary-side coil 8a and the secondary-side coil 15a on the basis of current detection in the power transmission unit 8 again while outputting a voltage pulse to the primary-side coil 8a in a conduction switching operation according to switching of the transmission power converting unit 7 in the search state (search mode) over the time t4 to a time t5. At the time t5 at which the coupling coefficient k has reached a predetermined value ka or more within a predetermined time, the power transmission-side control device 9 transitions the transmission power converting unit 7 from the search state (search mode) to the power transmission control state.

At the time t5 at which the reception power detected in the power reception standby state has reached a predetermined power or more within a predetermined time in accordance with reach of the coupling coefficient k to the predetermined value ka or more, the power reception-side control device 17 transitions the power reception device 4 from the power reception standby state to the power reception control state.

As described above, according to the contactless power transmission system 1 of the embodiment, by including the communication system M and the in-vehicle communication device 5 performing communication of first information (first communication) and the primary-side coil 8a and the secondary-side coil 15a performing communication of second information (second communication) and contactless power transmission, for example, a special communication device for communication of the second information (second communication) is not required, and the system configuration can be inhibited from being complicated.

For example, communication of first information of which the volume is large can be performed using the communication system M and the in-vehicle communication device 5, and communication of second information, of which the volume is small, required only for at least identification of the vehicle V can be performed using the primary-side coil 8a and the secondary-side coil 15a. Since power transmission is contactlessly executed using the primary-side coil 8a and the secondary-side coil 15a of which paring has been formed in accordance with communication and collation of key information, appropriate power transmission control and power reception control can be executed with high reliability.

For example, also in a case in which a plurality of sets of combinations of the primary-side coil 8a and the transmission power converting unit 7 are connected to a common power supply unit 6, communication and collation of key information and power transmission are independently controlled for each of the combinations. In accordance with this, for example, even in a case in which a plurality of traveling vehicles V of which requested powers are different from each other are present under a mixed traffic environment in which inter-vehicle distances become small, and an interrupt occurs or the like, power transmission can be individually performed with an appropriate timing including a simultaneous timing and appropriate power for each of the plurality of traveling vehicles V. For each vehicle V, communication using the primary-side coil 8a and the secondary-side coil 15a is performed in the communication section CS, and thus occurrence of interference with other vehicles V can be suppressed. Since power transmission using the primary-side coil 8a and the secondary-side coil 15a is performed in the power transmission section TS adjacent to the communication section CS, appropriate power transmission according to requested power can be performed for each vehicle V.

By providing the search state (search mode) of the transmission power converting unit 7, in a case in which the degree of coupling (for example, the coupling coefficient k) between the primary-side coil 8a and the secondary-side coil 15a of which paring has been formed has reached a predetermined threshold level (for example, the predetermined value ka) or more, which is appropriate for power transmission, power transmission control can be appropriately executed.

By providing the short-circuit state of the reception power converting unit 16, unnecessary communication from the secondary-side coil 15a to the primary-side coil 8a can be prevented. By providing the power reception standby state of the reception power converting unit 16, appropriate voltage detection can be performed in correspondence with the search state (search mode) of the transmission power converting unit 7. In addition, in a case in which the reception power has been appropriately increased in accompaniment with an increase in the degree of coupling between the primary-side coil 8a and the secondary-side coil 15a of which pairing has been formed, power reception control can be appropriately executed.

### Modified Example

In the embodiment described above, for example, in the case of a hybrid vehicle driving the energy storage device 11 and an internal combustion engine as drive sources or the like, the contactless power transmission system 1 may include stored voltage converting unit that converts input/output power of the energy storage device 11.

The embodiments of the present invention are presented as examples and are not intended to limit the scope of the invention. These embodiments can be performed in other various forms, and various omissions, substitutions, and modifications can be performed in a range not departing from the concept of the invention. Similar to the case of being included in the scope and the concept of the invention, these embodiments and modifications thereof are included in the scope of the invention described in the claims and equivalency thereof

What is claimed is:

1. A contactless power transmission system comprising:
a power reception-side coil, a power reception-side communication device, and a power reception-side control device configured to be mounted in a mobile body; and
a power transmission device having at least one power transmission-side coil, a power transmission-side communication device, and a power transmission-side control device configured to be disposed in a movement path of the mobile body,
wherein the power reception-side communication device and the power transmission-side communication device transmit/receive first information using wireless first communication before a degree of coupling between the power reception-side coil and the power transmission-side coil reaches a predetermined level or more,
wherein, after the first communication between the power reception-side communication device and the power transmission-side communication device or in a case in which the power reception-side coil and the power transmission-side coil are within a predetermined distance, the power reception-side coil transmits second information to the power transmission-side coil using second communication using an induced voltage of magnetic coupling,
wherein the power transmission-side coil contactlessly transmits power to the power reception-side coil after the second communication with the power reception-side coil, and
wherein the power reception-side control device and the power transmission-side control device control communication of the first information and the second information and control contactless power transmission between the power reception-side coil and the power transmission-side coil on the basis of the first information and the second information.

2. The contactless power transmission system according to claim 1,
wherein the first information transmitted from the power reception-side communication device to the power transmission-side communication device includes at least information relating to power transmission,
wherein the first information transmitted from the power transmission-side communication device to the power reception-side communication device includes at least key information, and
wherein the second information includes at least the key information.

3. The contactless power transmission system according to claim 2,
wherein the power transmission device includes at least one power transmission-side power converting unit that is connected to each of at least one power transmission-side coil and independently converts power supplied from a power supply, and
wherein the power transmission-side control device independently controls contactless power transmission using each of at least one power transmission-side coil in accordance with the information relating to power transmission associated with the key information received from the power reception-side coil by each of at least one power transmission-side coil on the basis of a combination of the key information and the information relating to power transmission.

4. The contactless power transmission system according to claim 3, wherein the power transmission-side control device:
transitions the power transmission-side power converting unit from a stop state to a reception standby state of the second information after the key information is transmitted from the power transmission-side communication device to the power reception-side communication device;
transitions the power transmission-side power converting unit from the reception standby state to a search state in which a voltage pulse is output for estimating the degree of coupling after completion of collation of the key information received from the power reception-side coil by the power transmission-side coil; and
transitions the power transmission-side power converting unit to a power transmission control state in a case in which the degree of coupling has reached a predetermined threshold level or more in the search state and transitions the power transmission-side power converting unit to the reception standby state in a case in which the degree of coupling has not reached the predetermined threshold level or more in the search state.

5. The contactless power transmission system according to claim 4, further comprising:
a power reception-side power converting unit that is mounted in the mobile body and is connected to the power reception-side coil,
wherein the power reception-side control device:
transitions the power reception-side power converting unit from a short-circuit state of the power reception-side coil to a transmission state of the second information after the key information is received from the power transmission-side communication device by the power reception-side communication device and transitions the power reception-side power converting unit from the transmission state to a power reception standby state of power after transmission of the second information; and
transitions the power reception-side power converting unit to a power reception control state in a case in which a reception power has reached a predetermined power or more within a predetermined time in the power reception standby state and transitions the power reception-side power converting unit to the transmission state in a case in which the reception power has not reached the predetermined power or more within the predetermined time in the power reception standby state.

6. A power transmission device comprising:
at least one power transmission-side coil configured to be disposed in a movement path of a mobile body and contactlessly transmit power to a power reception-side coil mounted in the mobile body;
a power transmission-side communication device configured to transmit/receive first information using wireless first communication with a power reception-side communication device mounted in the mobile body before a degree of coupling between the power transmission-side coil and the power reception-side coil reaches a predetermined level or more; and
a power transmission-side control device configured to control contactless power transmission between the power reception-side coil and the power transmission-side coil on the basis of second information received by the power transmission-side coil using second communication using an induced voltage of magnetic coupling between the power reception-side coil and the power transmission-side coil and the first information.

7. The power transmission device according to claim 6, further comprising at least one power transmission-side power converting unit that is connected to each of at least one power transmission-side coil and independently converts power supplied from a power supply,
wherein the first information received from the power reception-side communication device by the power transmission-side communication device includes at least information relating to power transmission,
wherein the first information transmitted to the power reception-side communication device by the power transmission-side communication device includes at least key information,
wherein the second information includes at least the key information, and
wherein the power transmission-side control device independently controls contactless power transmission using each of at least one power transmission-side coil in accordance with the information relating to power transmission associated with the key information received by each of at least one power transmission-side coil from the power reception-side coil on the basis of a combination of the key information and the information relating to power transmission.

8. The power transmission device according to claim 7, wherein the power transmission-side control device:
transitions the power transmission-side power converting unit from a stop state to a reception standby state of the second information after the key information is transmitted from the power transmission-side communication device to the power reception-side communication device;
transitions the power transmission-side power converting unit from the reception standby state to a search state in which a voltage pulse is output for estimating the degree of coupling after completion of collation of the key information received from the power reception-side coil by the power transmission-side coil; and
transitions the power transmission-side power converting unit to a power transmission control state in a case in which the degree of coupling has reached a predetermined threshold level or more in the search state and transitions the power transmission-side power converting unit to the reception standby state in a case in which the degree of coupling has not reached the predetermined threshold level or more in the search state.

9. A mobile body comprising:
a power reception-side coil configured to receive power contactlessly transmitted from a power transmission-side coil;
a power reception-side communication device configured to transmit/receive first information using wireless first communication with a power transmission-side communication device included in a power transmission device before a degree of coupling between the power transmission-side coil and the power reception-side coil reaches a predetermined level or more; and
a power reception-side control device configured to transmit second information to the power transmission-side coil using second communication using an induced voltage of magnetic coupling between the power reception-side coil and the power transmission-side coil.

10. The mobile body according to claim 9, further comprising a power reception-side power converting unit configured to be connected to the power reception-side coil,
wherein the first information transmitted to the power transmission-side communication device by the power reception-side communication device includes at least information relating to power transmission,
wherein the first information received from the power transmission-side communication device by the power reception-side communication device includes at least key information,
wherein the second information includes at least the key information, and
wherein the power reception-side control device:
transitions the power reception-side power converting unit from a short-circuit state of the power reception-side coil to a transmission state of the second information after the key information is received from the power transmission-side communication device by the power reception-side communication device and transitions the power reception-side power converting unit from the transmission state to a power reception standby state of power after transmission of the second information; and
transitions the power reception-side power converting unit to a power reception control state in a case in which a reception power has reached a predetermined power or more within a predetermined time in the power reception standby state and transitions the power reception-side power converting unit to the transmission state in a case in which the reception power has not reached the predetermined power or more within the predetermined time in the power reception standby state.
